(19) United States
(12) Patent Application Publication
(10) Pub. No.: US 2016/0099656 A1
(43) Pub. Date: Apr. 7, 2016

(54) NON-ISOLATED AC-DC CONVERSION POWER SUPPLY

(71) Applicants: Shivam Mishra, Gorakhpu (IN); Puneet Arora, Delhi (IN); Mohammad Kamil, Mango Jamshedpur (IN); Amit Tiwari, Noida (IN)

(72) Inventors: Shivam Mishra, Gorakhpu (IN); Puneet Arora, Delhi (IN); Mohammad Kamil, Mango Jamshedpur (IN); Amit Tiwari, Noida (IN)

(73) Assignee: Freescale Semiconductor, Inc., Austin, TX (US)

(21) Appl. No.: 14/509,041

(22) Filed: Oct. 7, 2014

(51) Int. Cl. H02M 7/06

(52) U.S. Cl. CPC H02M 7/06

(57) ABSTRACT

A non-isolated capacitive AC-DC conversion power supply includes a current limiting input module that receives AC input power and has an output capacitor that supplies DC power. Charge storage stages have charge storage capacitors, a rectifier supplying rectified current from the input module to charge the charge storage capacitors and the output capacitor during a first part-cycle of the AC input power. The charge storage stages also include current amplifiers and unidirectional elements that conduct discharge current from the charge storage capacitors to charge the output capacitor during a second part-cycle of the AC input power. Ground of the DC output can be connected to the live AC input.

### BACKGROUND OF THE INVENTION

The present invention is directed to power supplies and, more particularly, to a non-isolated alternating current-direct current (AC-DC) conversion power supply.

An isolated AC-DC conversion power supply converts an AC power input to a DC power output and isolates the power output electrically from the power input. A transformer is often used to isolate the output from the input and may also convert the AC input voltage to a different voltage. However, there are circumstances where isolation of the power output from the power input is unnecessary.

Transformers are often large, heavy and costly and can consume power in standby conditions. Also, a transformer or inductor-based converter may be undesirable in specific DC power supply applications. An example is the power supply for a smart meter, where tamper techniques include applying a strong magnetic field to the meter to falsify its operation. Counter-measures in the meter could be rendered ineffective if the magnetic field also magnetically saturated the transformer or inductor and caused insufficient output voltage from the power supply.

A non-isolated capacitive AC-DC conversion power supply has rectifier elements and capacitive elements to provide a DC output voltage. A non-isolated capacitive AC-DC conversion power supply is desired that is stable, sufficiently free from ripple, consumes a low level of real (active) and apparent input power, and is cost-effective.

### BRIEF DESCRIPTION OF THE DRAWINGS

The present invention, together with objects and advantages thereof, may best be understood by reference to the following description of embodiments thereof shown in the accompanying drawings. Elements in the drawings are illustrated for simplicity and clarity and have not necessarily been drawn to scale.

FIG. 1 is a schematic circuit diagram of a non-isolated capacitive AC-DC conversion power supply in accordance with an embodiment of the present invention;

FIG. 2 is a schematic block diagram of electronic equipment including an electronic device and a non-isolated capacitive AC-DC conversion power supply for the device in accordance with an embodiment of the present invention; and

FIGS. 3 to 6 are graphs against time of voltages and currents occurring in operation of the power supply of FIG. 1.

### DETAILED DESCRIPTION

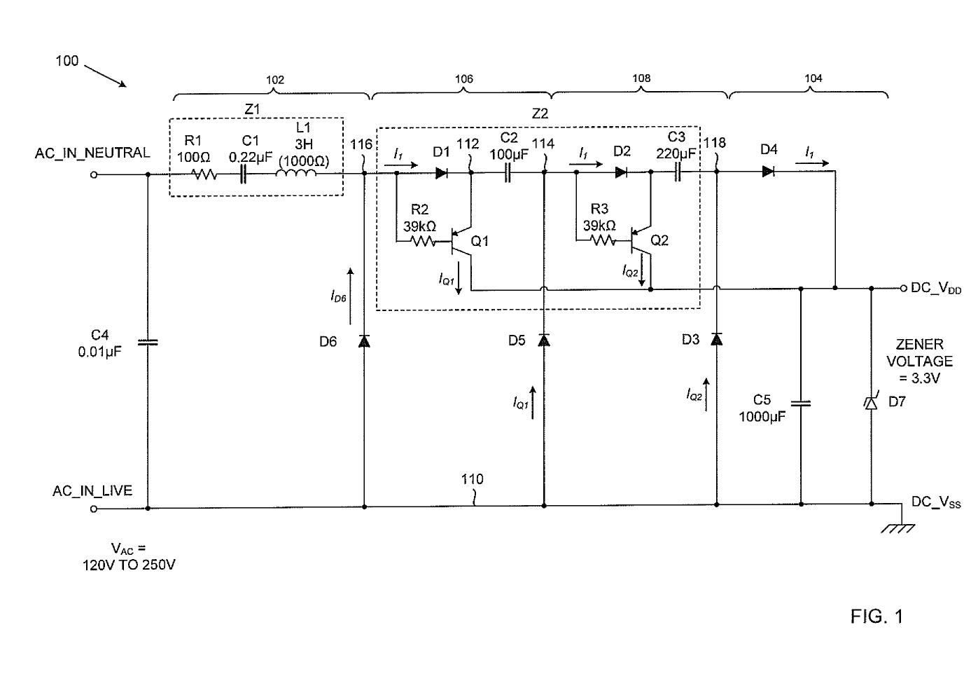

FIG. 1 illustrates an example of a non-isolated capacitive alternating current-direct current (AC-DC) conversion power supply 100 in accordance with an embodiment of the present invention. The power supply 100 includes an input section 102 for receiving AC input power and including a current limiting input module, and an output section 104 for supplying DC power and including an output capacitor C5. The power supply 100 also includes at least a first charge storage stage 106 having a charge storage capacitor C2, a rectifier module D1 connected to supply rectified current I₁ from the input module 102 to charge the charge storage capacitor C2 and the output capacitor C5 during a first part-cycle P1, P4 of the AC input power. The charge storage stage 106 also includes a current amplifier R2, Q1 and a unidirectional element D5 connected to supply discharge current I_{Q1} from the charge storage capacitor C2 to charge the output capacitor C5 during a second part-cycle P2, P3 of the AC input power.

The current limiting input module enables the power drawn from the AC input to be limited, while the charge storage stage 106 transfers sufficient additional energy to the output stage 104 when charging the output capacitor C5 to provide the desired output power. Examples of the power supply 100 can be integrated with or separate from a device to which it supplies power and can be of small physical dimensions.

The power supply 100 may further include at least a second charge storage stage 108 having a second charge storage capacitor C3, a second rectifier module D2 connected to supply the rectified current I₁ from the first charge storage stage to charge the second charge storage capacitor C3 during the first part-cycle P1, P4. The second charge storage stage 108 also includes a second current amplifier R3, Q2 and a second unidirectional element D3 connected to supply discharge current I_{Q2} from the second charge storage capacitor C3 to charge the output capacitor C5 during the second part-cycle P2, P3. The power supply 100 may include more than two charge storage stages such as 106 and 108.

The output stage 104 may include a unidirectional element D4 connected between the charge storage stage 106, 108 and the output capacitor C5 to pass the rectified current I₁ charging the output capacitor C5 during the first part-cycle P1, P4 and to prevent the output capacitor C5 discharging into the charge storage stage 106, 108 during the second part-cycle P2, P3.

The current limiting input module 102 may include an input capacitor C1 connected in series for charging with a first polarity during a portion P1 of the first part-cycle. The input section 102 may include a unidirectional connection D6 for charging the input capacitor C1 with a polarity opposite to the first polarity during a portion P3 of the second part-cycle. The input capacitor C1 can subsequently discharge to supply the rectified current I₁ to charge the charge storage capacitor C2, C3 and the output capacitor C5 during a further portion P4 of the first part-cycle.

The input section 102 may have first and second input terminals AC_IN_LIVE and AC_IN_NEUTRAL for receiving AC voltage from live and neutral mains power supply lines respectively, and the output section 104 having a voltage output terminal DC_V_{DD} and a ground output terminal DC_V_{SS} for supplying DC voltage, wherein the first input terminal AC_IN_LIVE is connected to the ground output terminal DC_V_{SS}. The output capacitor C5 is connected between the voltage output terminal DC_V_{DD} and the ground output terminal DC_V_{SS}. A ground bus 110 connects the first input terminal AC_IN_LIVE to the ground output terminal DC_V_{SS}.

The output section may include a voltage regulator element D7 connected to regulate the DC voltage provided by the output section 104. The voltage regulator element D7 may be a zener diode connected across the output capacitor C5.

The charge storage capacitor C2 may be connected between first and second nodes 112 and 114. The rectifier module D1 is connected between the first node 112 and a third node 116 at the input section 102. The current amplifier R2, Q1 has a control terminal connected to the input section 102 and a current conduction path connected between the first node 112 and the output capacitor C5. The unidirectional element D5 is connected between the second node 114 and the output capacitor C5. The second charge storage stage 108 may have a similar structure. The active amplifier elements Q1 and Q2 may be bipolar transistors.

Another feature of the embodiment of the invention shown in FIG. 1 is that the non-isolated capacitive AC-DC conversion power supply 100 comprises at least a first charge storage stage 106 having a charge storage capacitor C2 and a charge-discharge module D1, R2, Q1. The charge-discharge module D1, R2, Q1 is connected to supply rectified current from the input section 102 to charge the charge storage capacitor C2 and the output capacitor C5 during a first part-cycle P1, P4 of the AC input power and to supply discharge current I_{Q1} from the charge storage capacitor C2 to charge the output capacitor C5 during a second part-cycle P2, P3 of the AC input power. The input capacitor C1 is connected in series for charging with a first polarity during a portion P1 of the first part-cycle. The input section 102 includes a unidirectional connection D6 for charging the input capacitor with a polarity opposite to the first polarity during a portion P3 of the second part-cycle. The input capacitor C1 subsequently discharges to supply the rectified current I₁ to charge the charge storage capacitor C2 and the output capacitor C5 during a further portion P4 of the first part-cycle. This increases the voltage to which the charge storage capacitor C2 can be charged through the input capacitor C1.

The current limiting input capacitor C1, in this example 0.22 μF, may be much smaller than the storage capacitors C2 and C3, in this example 100 μF and 220 μF respectively, limiting the current drawn from the input terminals AC_IN_NEUTRAL and AC_IN_LIVE, and the input impedance of the power supply 100 is essentially capacitive. The output capacitor C5, 1000 μF in this example, is substantially bigger than the storage capacitors C2 and C3.

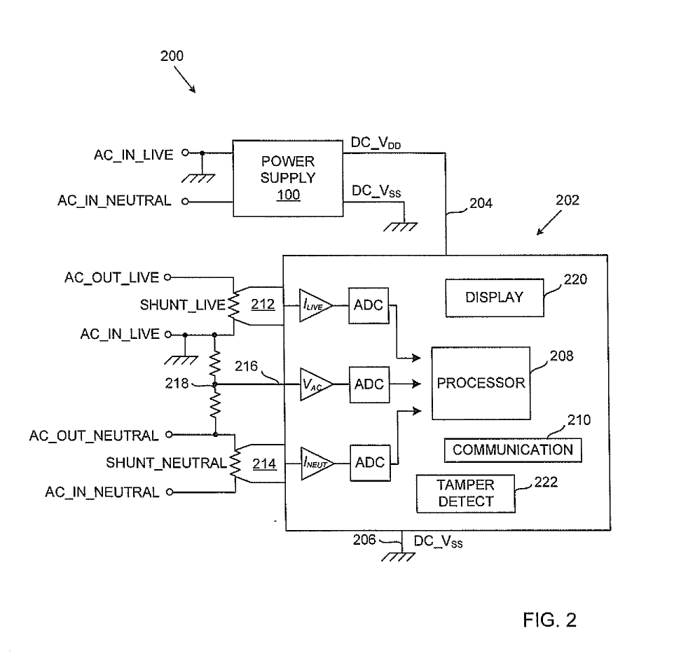

FIG. 2 illustrates an example of electronic equipment 200 including an electronic device 202 having a DC voltage power supply terminal 204 and a ground terminal 206, and a non-isolated capacitive alternating current-direct current (AC-DC) conversion power supply, 100 in accordance with an embodiment of the present invention. The power supply 100 comprises an input section 102 having first and second input terminals AC_IN_LIVE and AC_IN_NEUTRAL for receiving AC voltage from live and neutral mains power supply lines respectively, and a current limiting input module 102. An output section of the power supply 100 has an output capacitor C5, and a voltage output terminal DC_V_{DD} and a ground output terminal DC_V_{SS} for supplying DC power to the device 202. At least one charge storage stage 106, 108 of the power supply 100 has a charge storage capacitor C2, C3, a rectifier module D1, D2 connected to supply rectified current I₁ from the input module 102 to charge the charge storage capacitor C2, C3 and the output capacitor C5 during a first part-cycle P1, P4 of the AC input power. A current amplifier R2 and Q1, R3 and Q2 of the charge storage stage 106, 108 and a unidirectional element D5, D3 are connected to supply discharge current I_{Q1}, I_{Q2} from the charge storage capacitor C2, C3 to charge the output capacitor C5 during a second part-cycle P2, P3 of the AC input power. The ground output terminal DC_V_{SS} of the output section 104 is connected to the ground terminal 206 of the device 202 and to the first input terminal AC_IN_LIVE of the input section 102.

The device 202 may be an electrically powered meter, which may be an electricity meter for measuring consumption of electrical energy. The meter 202 may include a digital processor 208 and a communication module 210 for communicating digital data. The configuration with the ground terminal 206 of the device 202 connected to the first input terminal AC_IN_LIVE is desirable, especially for certain applications of electricity meters, for example.

In more detail, the input section 102 has a resistor R1 and an inductor L1 connected in series with the capacitor C1 between the input terminal AC_IN_NEUTRAL and the node 116 connected to the rectifier D1 of the first charge storage stage 106. A small capacitor C4 is connected across the input terminals AC_IN_LIVE and AC_IN_NEUTRAL. The inductor L1 is a bead inductor having a low impedance at the frequency of the AC mains input power but a high impedance for high frequencies. The combination of the inductor L1 and the resistor R1 improve the power factor at the input. The combination of the inductor L1 and the capacitor C4 filter high frequency noise.

In the example of power supply shown in FIG. 1, the power supply 100 supplies DC voltage with a positive polarity on the voltage output terminal DC_V_{DD} relative to the ground output terminal DC_V_{SS}. The unidirectional elements D6, D5 and D3 are diodes having their anodes connected to the ground bus 110 and the input terminal AC_IN_LIVE. The cathodes of the diodes D6, D5 and D3 are connected to the node 116, to the node 114 between the diode D2 and the charge storage capacitor C2, and to a node 118 between the diode D4 and the charge storage capacitor C3, respectively. The rectifier modules D1 and D2 and the unidirectional element D4 are diodes connected in series, with their anodes connected to the preceding stages 102, 106 and 108, and their cathodes connected to the following capacitors C2, C3 and C5, respectively. The transistors Q1 and Q2 are pnp transistors. It will be appreciated that the polarities may be inverted, if desired.

In the example shown in FIG. 2, the device 202 is an electricity meter for measuring consumption of electrical energy, and has signal inputs 212, 214 and 216 connected to the electrical AC mains supply, which may be single-phase or poly-phase. The AC mains supply has a live (phase) line connected to the same terminal AC_IN_LIVE as the power supply 100 and a neutral line connected to the terminal AC_IN_NEUTRAL. The AC metered power is delivered through terminals AC_OUT_LIVE and AC_OUT_NEUTRAL. The signal input 212 monitors the live current I_{LIVE} passing through a small shunt resistance SHUNT_LIVE connected between the terminals AC_IN_LIVE and AC_OUT_LIVE. The signal input 214 monitors the neutral current I_{NEUTRAL} passing through a small shunt resistance SHUNT_NEUTRAL connected between the terminals AC_IN_NEUTRAL and AC_OUT_NEUTRAL. The signal input 216 monitors the mains voltage VAC through a voltage divider 218 connected between the terminals AC_IN_LIVE and AC_OUT_NEUTRAL.

The input signals pass through buffer amplifiers and analog-to-digital converters (ADC), are processed in the digital processor 208 and displayed on a display 220. The communication module can enable two-way communication with a data center at the electricity supply utility. The device 202 also includes a tamper detection module 222.

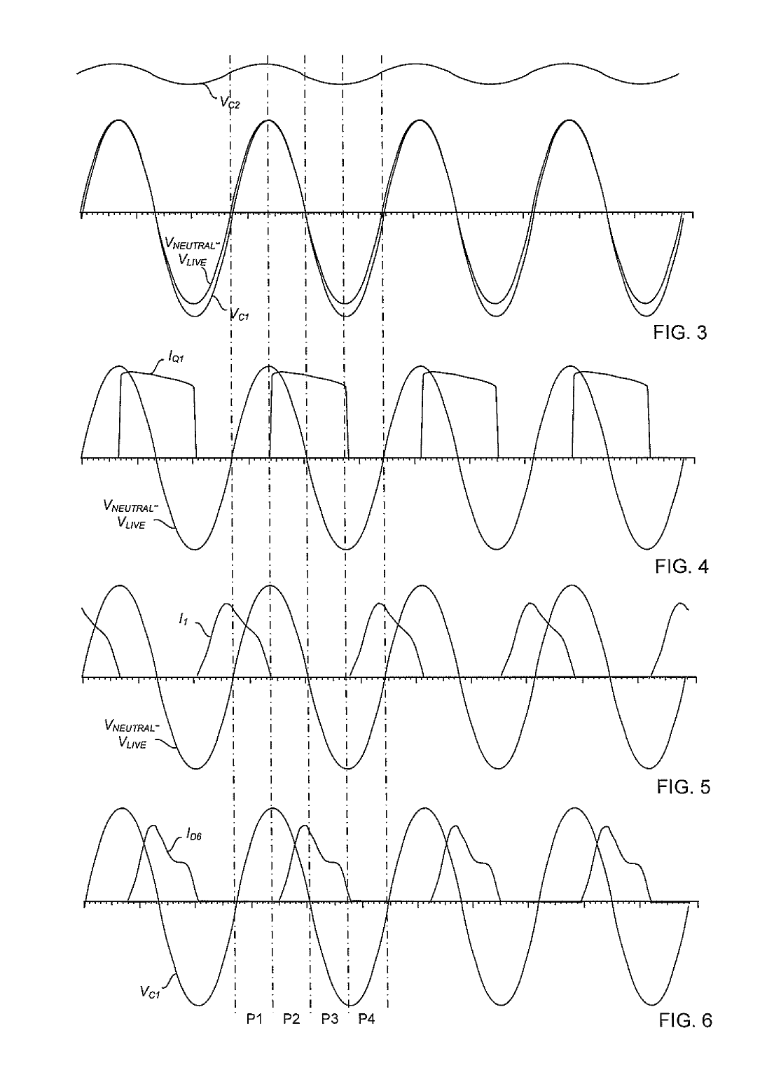

FIGS. 3 to 6 illustrate the variations of voltages and currents occurring in operation of the power supply 100 against time, the vertical scales of the graphs not necessarily being the same. The first and second part-cycles of the AC power each include two quarter-cycles P1, P4 and P2, P3 respectively. As shown in FIG. 3, the voltage V_{C1} across the input capacitor C1 and the voltage V_{C2} across the charge storage capacitor C2 are almost in phase with the input AC voltage V_{IN}, and the voltage V_{C2} has a DC component.

In the quarter-cycle P1, the voltage of the terminal AC_IN_NEUTRAL is higher than the terminal AC_IN_LIVE. The rectified current I₁, shown in FIG. 5, charges the input capacitor C1, the charge storage capacitors C2 and C3 and the output capacitor C5 through the diodes D1, D2 and D4 in series until the input capacitor C1 is fully charged. The zener diode D7 conducts when the output voltage across the output terminals DC_V_{DD} and DC_V_{SS} exceeds the zener point to divert the current I₁ from the output capacitor C5 and regulate the output voltage. The bases of the transistors Q1 and Q2 are pulled up to above the potential of their emitters by the forward-bias voltage of the diodes D1 and D2 through the resistors R2 and R3 and are cut off.

In the quarter-cycle P2, the voltage at the terminal AC_IN_NEUTRAL starts to reduce and the voltage V_{C1} across the capacitor C1 brings the voltage of the node 116 down, reverse biasing the diodes D1, D2 and D4 and cutting them off. The reverse bias on diodes D1 and D2 switches transistors Q1 and Q2 on to conduct currents I_{Q1} (shown in FIG. 4) and I_{Q2}. The currents I_{Q1} and I_{Q2} discharge the charge storage capacitors C2 and C3 into the output capacitor C5, the return path for the currents I_{Q1} and I_{Q2} flowing through the ground bus 110, and through the diodes D5 and D3 respectively. A current I_{D5}, shown in FIG. 6, flows through the diode D6 and discharges the capacitor C1.

In the quarter-cycle P3, the voltage at the terminal AC_IN_NEUTRAL inverts its polarity relative to the terminal AC_IN_LIVE. The transistors Q1 and Q2 remain conductive and the currents I_{Q1} and I_{Q2} continue to discharge the charge storage capacitors C2 and C3 into the output capacitor C5. The current I_{D6} through the diode D6 charges the capacitor C1 with the opposite polarity with respect to its polarity during the quarter-cycle P1.

In the quarter-cycle P4, the voltage across the input terminals AC_IN_NEUTRAL and AC_IN_LIVE reduces. The voltage across the capacitor C1 raises the node 116 to a higher level than the input terminal AC_IN_LIVE, cutting off the current I_{D6} through the diode D6. The diodes D1, D2 and D4 turn on. The input capacitor C1 then discharges to supply the rectified current I₁ to charge the charge storage capacitor C2, C3 and the output capacitor C5, before charging with the opposite polarity during the next quarter-cycle P1, when the full cycle starts again.

In the foregoing specification, the invention has been described with reference to specific examples of embodiments of the invention. It will, however, be evident that various modifications and changes may be made therein without departing from the broader spirit and scope of the invention as set forth in the appended claims.

Although specific conductivity types or polarity of potentials have been described in the examples, it will be appreciated that conductivity types and polarities of potentials may be reversed.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, a capacitor, an inductor or a resistor may be formed of two or more capacitive, inductive or resistive elements connected together to achieve the desired impedance. Similarly, any arrangement of components to achieve the same functionality is effectively “associated” such that the desired functionality is achieved. Hence, any two components combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Also for example, in one embodiment, the illustrated examples may be implemented as circuitry located on a single integrated circuit (IC) or within a same device. Alternatively, the examples may be implemented as any number of separate elements, integrated circuits or separate devices interconnected with each other in a suitable manner. For example, the power supply 100 and the powered device 202 may be separate elements interconnected on a printed circuit board (PCB) or may partly be integrated in a common IC.

In the claims, the word ‘comprising’ or ‘having’ does not exclude the presence of other elements or steps then those listed in a claim. Furthermore, the terms “a” or “an” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A non-isolated capacitive alternating current-direct current (AC-DC) conversion power supply, comprising:
an input section for receiving AC input power and including a current limiting input module;
an output section for supplying DC power and including an output capacitor; and
at least a first charge storage stage having a charge storage capacitor, a rectifier module connected to supply rectified current from the input module to charge the charge storage capacitor and the output capacitor during a first part-cycle of the AC input power, and a current amplifier and a unidirectional element connected to supply discharge current from the charge storage capacitor to charge the output capacitor during a second part-cycle of the AC input power, wherein the current amplifier comprises a transistor, and the rectifier module is connected between base and emitter terminals of the transistor and controlled by a reverse bias on the transistor.

2. The power supply of claim 1, further comprising:
a second charge storage stage having a second charge storage capacitor, a second rectifier module connected to supply the rectified current from the first charge storage stage to charge the second charge storage capacitor during the first part-cycle, and a second current amplifier and a second unidirectional element connected to supply discharge current from the second charge storage capacitor to charge the output capacitor during the second part-cycle.

3. The power supply of claim 1, wherein the output stage includes a unidirectional element connected between the charge storage stage and the output capacitor to pass the rectified current charging the output capacitor during the first part-cycle and to prevent the output capacitor discharging into the charge storage stage during the second part-cycle.

4. The power supply of claim 1, wherein the current limiting input module includes an input capacitor connected in series for charging with a first polarity during a portion of the first part-cycle.

5. The power supply of claim 4, wherein the input section includes a unidirectional connection for charging the input capacitor with a polarity opposite to the first polarity during a portion of the second part-cycle, the input capacitor subsequently discharging to supply the rectified current to charge the charge storage capacitor and the output capacitor during a further portion of the first part-cycle.

6. The power supply of claim 1, wherein the input section has first and second input terminals for receiving AC voltage from live and neutral mains power supply lines respectively, and the output section has a voltage output terminal and a ground output terminal for supplying DC voltage, wherein the first input terminal is connected to the ground output terminal.

7. The power supply of claim 1, wherein the output section includes a voltage regulator connected to regulate the DC voltage provided by the output section.

8. The power supply of claim 1, wherein the charge storage capacitor is connected between first and second nodes, the rectifier module is connected between the first node and a third node at the input section, the current amplifier has a control terminal connected to the input section and a current conduction path connected between the first node and the output capacitor, and the unidirectional element is connected between the second node and the output capacitor.

9. A non-isolated capacitive alternating current-direct current (AC-DC) conversion power supply, comprising:
an input section for receiving AC input power and including a current limiting input capacitor;
an output section for supplying DC power and including an output capacitor; and
at least a first charge storage stage having a charge storage capacitor, a charge-discharge module connected to supply rectified current from the input section to charge the charge storage capacitor and the output capacitor during a first part-cycle of the AC input power and to supply discharge current from the charge storage capacitor to charge the output capacitor during a second part-cycle of the AC input power, wherein the charge-discharge module includes a rectifier module connected to supply the rectified current from the input section, and a current amplifier and a unidirectional element connected to supply the discharge current from the charge storage capacitor, wherein the current amplifier comprises a transistor, and the rectifier module is connected between base and emitter terminals of the transistor and controlled by a reverse bias on the transistor,
and wherein the input capacitor is connected in series for charging with a first polarity during a portion of the first part-cycle, and the input section includes a unidirectional connection for charging the input capacitor with a polarity opposite to the first polarity during a portion of the second part-cycle, the input capacitor subsequently discharging to supply the rectified current to charge the charge storage capacitor and the output capacitor during a further portion of the first part-cycle.

10. (canceled)

11. The power supply of claim 10, and further including at least a second charge storage stage having a second charge storage capacitor, a second rectifier module connected to supply the rectified current from the first charge storage stage to charge the second charge storage capacitor during the first part-cycle, and a second current amplifier and a second unidirectional element connected to supply discharge current from the second charge storage capacitor to charge the output capacitor during the second part-cycle.

12. The power supply of claim 9, wherein the output stage includes a unidirectional element connected between the charge storage stage and the output capacitor to pass the rectified current charging the output capacitor during the first part-cycle and to prevent the output capacitor discharging into the charge storage stage during the second part-cycle.

13. The power supply of claim 9, wherein the input section has first and second input terminals for receiving AC voltage from live and neutral mains power supply lines respectively, and the output section has a voltage output terminal and a ground output terminal for supplying DC voltage, wherein the first input terminal is connected to the ground output terminal.

14. The power supply of claim 9, wherein the output section includes a voltage regulator connected to regulate the DC voltage provided by the output section.

15. Electronic equipment including an electronic device having a DC voltage power supply terminal and a ground terminal, and a non-isolated capacitive alternating current-direct current (AC-DC) conversion power supply connected to supply DC power to the electronic device, wherein the power supply comprises:
an input section having first and second input terminals for receiving AC voltage from live and neutral mains power supply lines respectively, and a current limiting input module;
an output section having an output capacitor, and a voltage output terminal and a ground output terminal for supplying DC power to the electronic device; and
at least one charge storage stage having a charge storage capacitor, a rectifier module connected to supply rectified current from the input module to charge the charge storage capacitor and the output capacitor during a first part-cycle of the AC input power, and a current amplifier and a unidirectional element connected to supply discharge current from the charge storage capacitor to charge the output capacitor during a second part-cycle of the AC input power, wherein the current amplifier comprises a transistor, and the rectifier module is connected between base and emitter terminals of the transistor and controlled by a reverse bias on the transistor,
and wherein the ground output terminal of the output section is connected to the ground terminal of the electronic device and to the first input terminal of the input section.

16. The electronic equipment of claim 15, wherein the output section includes a voltage regulator connected to regulate the DC voltage across the output terminals.

17. The electronic equipment of claim 15, wherein the device is an electrically powered meter.

18. The electronic equipment of claim 17, wherein the device is an electric meter for measuring consumption of electrical energy.

19. The electronic equipment of claim 17, wherein the meter includes a digital processor and a communication module for transmitting and receiving digital data.
